(19) United States
(12) Patent Application Publication
(10) Pub. No.: US 2026/0112807 A1
(43) Pub. Date: Apr. 23, 2026

(54) MIIM DIODE RECTIFYING ANTENNA

(71) Applicant: COMMISSARIAT A L'ENERGIE ATOMIQUE ET AUX ENERGIES ALTERNATIVES, Paris (FR)

(72) Inventors: Abdelkader ALIANE, Grenoble cedex 09 (FR); Hacile KAYA, Grenoble cedex 09 (FR); Rachid HIDA, Grenoble cedex 09 (FR)

(73) Assignee: COMMISSARIAT A L'ENERGIE ATOMIQUE ET AUX ENERGIES ALTERNATIVES, Paris (FR)

(21) Appl. No.: 19/359,880

(22) Filed: Oct. 16, 2025

(30) Foreign Application Priority Data
Oct. 18, 2024 (FR) FR2411365

(51) Int. Cl. H01Q 1/24; H01Q 9/28; H01Q 15/14; H01Q 21/00

(52) U.S. Cl. CPC H01Q 1/248; H01Q 9/28; H01Q 15/14; H01Q 21/0087

(57) ABSTRACT

The invention relates to a rectifying antenna comprising: an antenna; a diode of the MIIM type having a first metal layer, a first insulating layer made of a first electrical insulator of electron affinity φ₁, a second insulating layer made of a second electrical insulator of electron affinity φ₂ lower than φ₁, and a second metal layer. The second electrical insulator has a dielectric constant εᵣ₂ lower than the dielectric constant εᵣ₁ of the first electrical insulator, and is a silicon oxide with a thickness between 0.5 and 2 nm.

### TECHNICAL FIELD

The field of the invention is that of detectors of an electromagnetic radiation of the MIIM diode rectenna type, in other words rectifying antennas comprising an antenna absorbing the electromagnetic radiation coupled to an MIIM diode, also called “rectennas”. The invention finds application in particular in the fields of infrared or terahertz imaging, thermography, gas detection, as well as in that of energy conversion.

### PRIOR ART

Infrared and terahertz detectors that operate at room temperature may be, for example, bolometer-type thermal detectors. They may then comprise an absorbent membrane, suspended above a substrate containing a readout circuit, which contains a thermistor material the electrical resistance of which varies depending on the heating thereof. However, the performances of these thermal detectors are generally limited by the thermal time constant thereof, which may be in the order of ten milliseconds.

Infrared and terahertz detectors may also be rectifying devices comprising a detection antenna coupled to a diode, also called “rectifying antennas” or “rectennas”, where the diode may be of the MIM (metal-insulator-metal) or MIIM (metal-insulator-insulator-metal) type. These rectennas may have a much faster response time than that of bolometer-type thermal detectors, to the extent that the transit time of electrons by tunneling, throughout the insulating thin layer of the diode, is in the range of femtoseconds to nanoseconds.

FIG. 1A illustrates the block diagram of a rectenna A1, herein the case of an energy conversion application. It is formed by an antenna A10 adapted to absorb the incident electromagnetic radiation, and a rectifier element A20 such as a diode, herein of the MIM-type, electrically coupled to the antenna A10. In general, a DC filter A2 is connected in parallel to the diode A20 so as to keep only the continuous component of the rectified AC signal. The operating principle of such a rectenna A1 is as follows: the antenna A10 absorbs the incident electromagnetic radiation and converts it into a high-frequency electrical signal, which is transferred at the input of the diode A20. The diode A20 rectifies the AC electrical signal, and then the DC filter A2 keeps only the continuous component of the rectified electrical signal, to deliver it herein to an electrical load A3.

FIG. 1B illustrates an example of an energy band diagram of a MIM diode rectenna, herein in the case of an optical detection application. Such an antenna is described in particular in the article by de Grover & Moddel titled Applicability of Metal/Insulator/Metal (MIM) Diodes to Solar Rectennas, IEEE Journal of Photovoltaics, Vol. 1, no. 1, pp. 78-83, 2011. The MIM diode includes two metal layers (metals M1 and M2) between which the same insulating layer (electrical insulator I) is located. In particular, the diagram depends on the values of the work functions Ψ_{M1} and Ψ_{M2} of the metals M1 and M2, of the electron affinity φ_{I} of the insulator I, and of the bias voltage V_{D} applied to the MIM diode. Electrons can pass through the energy barrier according to various conduction mechanisms, for example by Fowler-Nordheim type tunneling or by direct tunneling, depending in particular on the heights φ_{L} and φ_{R} of the energy barriers. These various types of conduction mechanisms are described in particular in the article by Chiu titled A Review on Conduction Mechanisms in Dielectric Films, Advances in Materials Science and Engineering, vol. 2014, Article ID 578168, 18 pages, 2014. In this example, the conduction by tunneling is of the Fowler-Nordheim type.

As indicated in the article by Grover & Moddel 2011, in terms of performances, the MIM diode should have a high responsivity β, which corresponding to a measurement of the rectified DC signal as a function of the incident energy power. It is possible to determine it from the I(V) characteristic of the diode from the relationship: β=I″/(2I′), where I′ and I″ are the first and second derivatives of the electric current as a function of the electrical voltage I(V), at the bias voltage V_{D}. In addition, the diode should have a low dynamic resistance to obtain a good impedance matching with the antenna.

However, it seems that, for a MIM diode, that is to say a diode with one single insulating layer located between the two metal layers, the optimization of the responsivity leads to a degradation of the value of the dynamic resistance, and vice versa. Also, it does not seem possible to optimize both the responsivity and the dynamic resistance of a MIM diode. Yet, it seems that a MIIM diode, that is to say a diode with two insulating layers having different electron affinities, makes it possible to suppress this constraint, so that it is possible to configure the MIIM diode so that it has both a high responsivity and a low dynamic resistance. This is the case in particular when the MIIM diode enables conduction of charge carriers by resonant tunneling.

In this respect, FIG. 1C illustrates an example of an energy band diagram of a MIIM diode infrared rectenna configured to enable conduction of charge carriers, herein electrons, by resonant tunneling. This type of energy band diagram is described in particular in the article by Grover & Moddel titled Engineering the current-voltage characteristics of metal-insulator-metal diodes using double-insulator tunnel barriers, Solid-State Electron. 67, 94-99 (2012), as well as in that by Belkadi et al. titled Demonstration of resonant tunneling effects in metal-double-insulator-metal (MI²M) diodes, Nat Commun 12, 2925 (2021).

The resonant tunneling is present when the electrons pass through the insulating layers throughout a quantum well in the form of a rectangular triangle located between the two insulating layers. Electrons the energy of which corresponds to the energy levels of the almost-bound states of the quantum well can pass through the insulating layers and reach the metal layer M2 while minimizing reflection, thereby producing a higher electric current than in the case of a non-resonant tunneling. It should be noted that, in this example, the electrons pass through the first insulating layer by Fowler-Nordheim type tunneling, and the second insulating layer by direct tunneling. The Authors have demonstrated that, by using insulators with different electron affinities, it is possible to configure a resonant tunneling MIIM-type diode to obtain both a high responsivity and a low dynamic resistance, which cannot be obtained in the case of a MIM diode.

However, there is a need to further improve the performances of a MIIM-type diode rectenna, whether for infrared or terahertz detection, or energy conversion, applications.

### DISCLOSURE OF THE INVENTION

One objective of the invention is to overcome at least part of the drawbacks of the prior art, and more particularly to propose an MIIM-type diode rectenna the performances of which are improved.

For this purpose, the object of the invention is a rectifying antenna for detecting electromagnetic radiation, comprising: an antenna adapted to absorb the electromagnetic radiation; and a diode of the Metal-Insulator-Insulator-Metal (MIIM) type, electrically coupled to the antenna, successively comprising: a first metal layer, a first insulating layer made of a first electrical insulator of electron affinity φ₁, a second insulating layer made of a second electrical insulator of electron affinity φ₂ lower than φ₁, and a second metal layer.

According to the invention, the second electrical insulator has a dielectric constant εᵣ₂ lower than the dielectric constant εᵣ₁ of the first electrical insulator, and is a silicon oxide with a thickness between 0.5 and 2 nm.

Certain preferred but non-limiting aspects of this rectifying antenna are as follows.

The first electrical insulator may be selected from Al₂O₃, ZrO₂, HfO₂, ZnO and HfAlO, and preferably is HfO₂ or ZnO.

The first insulating layer may have a thickness between 0.5 and 4 nm.

The first metal layer, the first insulating layer, the second insulating layer, and the second metal layer may form a stack of dimensions between 40×40 nm and 100×100 nm.

In the diode, each of said metal and insulating layers may be in continuous contact with the neighboring layer over the entire surface thereof.

The rectifying antenna may comprise an electric source adapted to apply a non-zero bias electrical voltage V_{D} to the diode.

The electric source may be adapted to apply an electrical potential to the first and second metal layers, the electrical potential applied to the second metal layer being higher than that applied to the first metal layer.

The first metal layer may have an electrical potential equal to that of the second metal layer.

The rectifying antenna may comprise a reflector for the electromagnetic radiation of interest, located between a support substrate and the antenna, and spaced apart from the antenna so as to form a quarter-wave cavity.

The antenna may be adapted to absorb an infrared or terahertz electromagnetic radiation.

The invention also relates to an optoelectronic device, comprising an array of rectifying devices according to any one of the preceding features, identical to one another.

The invention also relates to a method for manufacturing a rectifying antenna according to any one of the preceding features, comprising the following steps:
producing a first conductive portion of the antenna;
producing the first metal layer of the diode, in electrical contact with the first conductive portion of the antenna;
producing a first continuous insulating layer, covering the first metal layer and the first conductive portion of the antenna;
producing a first opening, located at a so-called proximal end of the first conductive portion of the antenna, opening into the first metal layer;
producing the first insulating layer extending into the first opening and coming into contact with the first metal layer;
producing by ion beam assisted deposition the second insulating layer made of a silicon oxide with a thickness of between 0.5 and 2 nm, extending into the first opening and coming into contact with the first insulating layer;
producing the second metal layer, extending into the first opening and coming into contact with the second insulating layer;
producing a second conductive portion of the antenna, extending over and in contact with the second metal layer.

### BRIEF DESCRIPTION OF THE DRAWINGS

Other aspects, aims, advantages and features of the invention will become apparent upon reading the following detailed description of preferred embodiments thereof, provided by way of non-limiting example, and made with reference to the accompanying drawings wherein:

FIG. 1A, already described, is a schematic view of an antenna-coupled diode rectifying antenna, according to one example of the prior art;

FIG. 1B, already described, illustrates one example of an energy band diagram of an MIM diode rectifying antenna, according to one example of the prior art;

FIG. 1C, already described, illustrates an example of an energy band diagram of an MIIM diode rectifying antenna, according to one example of the prior art;

FIG. 2A and FIG. 2B are schematic and partial views, in cross-section (FIG. 2A and in top view (FIG. 2B), of a MIIM diode rectifying antenna according to one embodiment;

FIG. 3 illustrates a change in the responsivity β of an MIIM diode as a function of the bias voltage V_{D}, for various examples of electrical insulating materials and thicknesses of the insulating layers;

FIGS. 4A to 4J illustrate various steps of a method for manufacturing an MIIM diode rectifying antenna according to one embodiment.

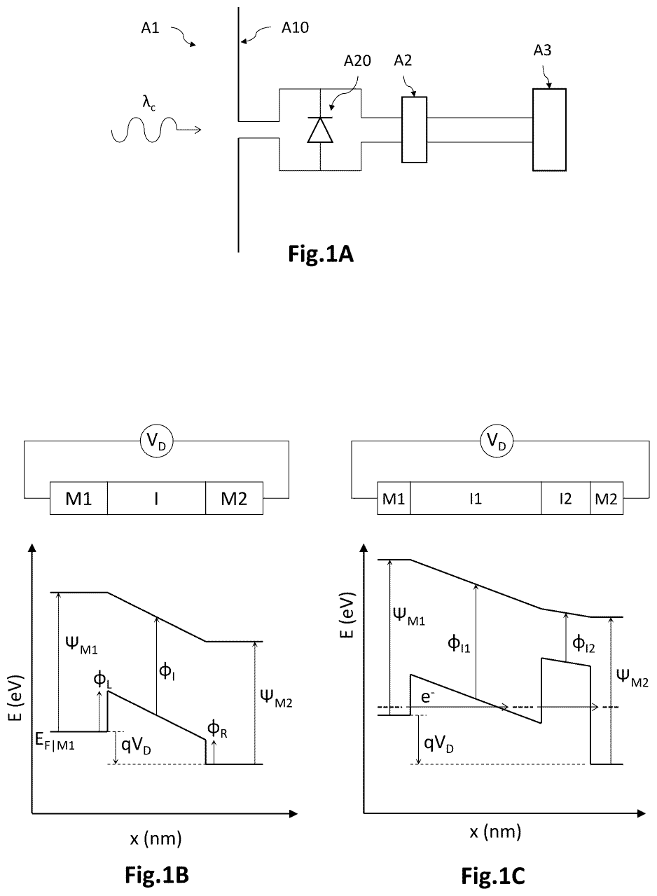

### DETAILED DISCLOSURE OF SPECIFIC EMBODIMENTS

In the figures and in the following description, the same references represent identical or similar elements. In addition, the various elements are not represented to scale so as to improve the clarity of the figures. Moreover, the various embodiments and alternative embodiments are not mutually exclusive and may be combined together. Unless stated otherwise, the terms “substantially”, “about”, and “in the order of” mean to within 10%, and preferably to within 5%. Moreover, the terms “between . . . and . . . ” and equivalents mean that the bounds are included, unless specified otherwise.

The invention relates to an electromagnetic radiation detector of the MIIM diode rectenna type, in other words a rectifying antenna comprising an antenna adapted to absorb the electromagnetic radiation coupled to an MIIM diode. In the following description, such a rectifying antenna is called a “rectenna”. It may serve as an infrared or terahertz detector, or even an energy converter, in particular according to whether the diode is biased, or not, at a non-zero voltage V_{D}.

In general, the antenna of the rectenna may be adapted to absorb an electromagnetic radiation of interest in a spectral range in particular from the infrared to the terahertz. Thus, the antenna may be configured to absorb in the Short Wavelength IR (SWIR) corresponding to a spectral range from about 0.8 to 2.7 μm; in the Middle Wavelength IR (MWIR) corresponding to a spectral range from about 3 to 5 μm; in the Long Wavelength IR (LWIR) corresponding to a spectral range from about 7 to 14 μm; or in the terahertz the spectral range of which extends from about 0.1 to 1 mm (about 0.3 to 3 THz).

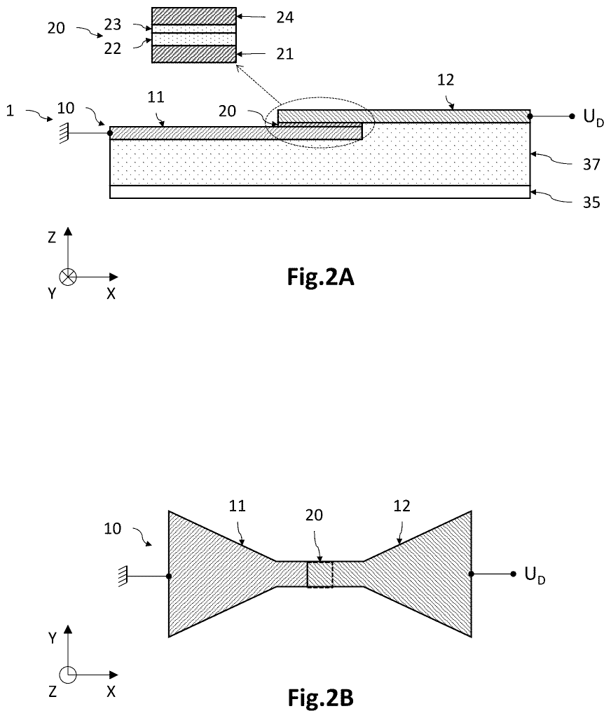

FIGS. 2A and 2B are schematic and partial views in longitudinal section (FIG. 2A) and in top view (FIG. 2B) of a rectenna according to one embodiment.

A three-dimensional direct reference frame XYZ is defined herein and for the remainder of the description, where the XY plane is parallel to the main plane of the antenna 10 of the rectenna 1, and where the Z-axis is oriented according to the thickness of the diode 20 of the rectenna 1. Moreover, the terms “lower” and “upper” should be understood relative to an increasing positioning according to the +Z direction.

In this example, the rectenna 1 is an infrared detector the antenna of which is adapted to absorb in the LWIR infrared, with a central wavelength equal to about 10 μm. Of course, the rectenna 1 may be configured to absorb in the other spectral ranges of the infrared, or in the terahertz.

Preferably, the described rectenna 1 belongs to an array of unit rectennas, identical to one another, connected to a control and readout electrical circuit (ROIC) in charge of biasing the diodes 20 and reading the generated electrical signals.

In general, the rectenna 1 conprises an antenna 10, the MIIM diode 20 and a DC filter (not shown). Here, it comprises an electric source to bias the MIIM diode at a non-zero voltage V_{D} (optical detection application). However, in the case of an energy conversion application (e.g. solar cell), the MIIM diode may be not biased or biased at a zero voltage, and may be connected to an electrical load.

The antenna 10 is adapted to absorb the incident electromagnetic radiation, herein an infrared radiation LWIR and is electrically connected to the MIIM diode 20 to transmit thereto the electrical signal generated in response to the absorption of the infrared radiation of interest.

The antenna 10 includes at least two electrically-conductive portions 11, 12, made of at least one absorbent metal, like for example Ti, TiN, Al, Au, Pt, inter alia. The conductive portions 11, 12 are aligned along a main detection axis X. In this example, the antenna 10 includes two conductive portions 11, 12 extending along the same main X-axis, but alternatively (not shown), it may comprise more conductive portions, for example four conductive portions two of which extend along a first main axis, and two extend along a second main axis orthogonal to the first axis.

The antenna 10 may have a spiral, serpentine, dipole, bow-tie shape. In this example, the antenna 10 is of the bow-tie type, also called bow-tie antenna. The two conductive portions 11, 12 have a substantially planar and triangular shape in the XY plane, where the apexes of the triangles are located opposite the diode 20, along the vertical Z-axis. The antenna 10 has a length L along the main X-axis in the range of λ_{c}/2, where λ_{c} is the central wavelength of the LWIR spectral range, for example herein about 10 μm. The angular opening of each triangular-shaped conductive portion 11, 12, defined at the apexes opposite the diode 20, may be equal to about 60°. Finally, the antenna may have a resistance R_{A} in the range of 100 Ω.

The two conductive portions 11, 12 are separated from one another, and are electrically connected to one another via the diode 20. They are disposed on either side of the diode 20 along the main X-axis. Thus, as illustrated in FIG. 2A, a lower conductive portion 11 is in electrical contact with a lower metal layer 21 of the diode 20, and an upper conductive portion 12 is in electrical contact with an upper conductive layer 24 of the diode 20.

The MIIM diode 20 is adapted to receive the high-frequency AC electrical signal generated by the antenna 10 in response to the absorption of the electromagnetic radiation of interest, herein in the LWIR, and to rectify it to deliver a rectified AC electrical signal.

The diode 20 is formed by a stack of the two metal layers 21, 24, between which at least two insulating layers 22, 23 are located. More specifically, the diode 20 includes the successive stacking of the following layers, which are in contact two by two: the first metal layer 21, the first insulating layer 22, the second insulating layer 23, and the second metal layer 24. In this example, this arrangement is carried out in the +Z direction, but it could be carried out in the opposite direction.

In this example, the stack of layers 21, 22, 23, 24, is oriented along the vertical Z-axis. The lower metal layer 21 is in electrical contact with the proximal end of the conductive portion 11 of the antenna 10, and the upper metal layer 24 is in electrical contact with the proximal end of the conductive portion 12. By proximal ends, it should be understood the ends of the conductive portions 11, 12 directed towards one another.

It should be noted that, in the diode 20, each of the layers 21, 22, 23, 24 extends parallel to the XY plane continuously, and is in continuous contact with the neighboring layer(s) over the entire surface thereof. The case where one of the layers would be formed by separate lines or grooves is thus distinguished, so that the neighboring layer would not be in contact, over the entire surface thereof, with the grooved layer.

The first metal layer 21 is made of at least one first metal M1, the work function of which is denoted Ψ_{M1}. It is herein in contact with the first insulating layer 22. The second metal layer 24 is made of at least one second metal M2, the work function of which is denoted Ψ_{M2}. Herein, it is in contact with the second insulating layer 23. The metal M1 may be selected in particular from Ti, Cr, TiN and AlCu, and the metal M2 may be selected, in this case where M1 is selected different from M2, from Ni, Pt, and Au.

In this case of an optical detection application, the two metals M1 and M2 may be identical or different in terms of work functions. However, in the case of an energy conversion application, the work functions Ψ_{M1}, Ψ_{M2} are different from one another. By work functions that are different from one another, it should be understood that the work function Ψ_{M1} of the metal M1 has a relative difference with respect to the work function Ψ_{M2} of the metal M2 higher than 10%. In other words, this gives ΔΨ_{M1M2}/Ψ_{M1}=|Ψ_{M1}−Ψ_{M2}|/Ψ_{M1}>10%. Preferably, the work function Ψ_{M2} is low relative to Ψ_{M1}, for example in the order of 4 eV.

The first insulating layer 22 is made of an electrical insulating material I1 of electron affinity φ₁ and of dielectric constant εr₁, and the second insulating layer 23 is made of an electrical insulating material I2 of electron affinity φ₂ and of dielectric constant εr₂. The dielectric constant corresponds to the relative permittivity.

The insulator I1 has an electron affinity φ₁ and a dielectric constant εr₁, respectively, greater than the electron affinity φ₂ and the dielectric constant εr₂ of the insulator I2. Preferably, the insulator I1 and the insulator I2 have a relative difference in electron affinity Δφ/φ₂=|φ₁−φ₂|/φ₂ at least equal to 50%, or even 100%, to 150%, or even more. Preferably, the insulator I1 and the insulator I2 have a relative difference in dielectric constant Δεr/εr₂=|εr₁−εr₂|/εr₂ at least equal to 100%, or even 200%, or more.

The insulator I1 may be aluminum, hafnium, zirconium, silicon, zinc oxide inter alia, such as for example Al₂O₃, HfO2, HfAlO, ZrO₂, ZnO. It is preferably a material with a particularly high dielectric constant (high-k material), such as for example Al₂O₃ (εr₁=6−7; φ₁=1.5 eV), HfO₂ (εr₁=10−12; φ₁=2.5 eV), ZrO₂ (εr₁=15−25; φ₁=2.9 eV) and ZnO (εr₁=8.5; φ₁=4.2 eV), which results in an increase in the asymmetry of the diode 20 and a reduction in the dynamic resistance thereof.

According to the invention, the insulator I2 is a silicon oxide, for example SiO₂, with a thickness between 0.5 and 2 nm (thickness of the insulating layer 23). It is a so-called low-k material in the sense that it has a low dielectric constant εr₂ equal to about 2 (for a thickness in the order of 1 nm). Moreover, it has an electron affinity φ₂ of 0.9 eV.

The insulating layer 22 has a thickness in the order of a few tenths of nanometers to a few nanometers, preferably a thickness between 0.5 and 4 nm, and preferably between 1 and 4 nm. Moreover, as indicated above, the insulating layer 23 has a thickness between 0.5 and 2 nm. The insulating layers may have the same thickness or different thicknesses.

The insulating layer 22 is a thin layer, that is to say a layer produced by conventional microelectronics techniques, of which chemical deposition (CVD, ALD, etc.), physical deposition (PVD, etc.), inter alia. The insulating layer 23 made of a silicon oxide of 0.5 to 2 nm is a thin layer produced by Ion Beam Assisted Deposition (IBAD) at room temperature. It is not deposited by very thin film formation techniques such as Atomic Layer Deposition (ALD).

Thus, the insulating layer of SiO₂ deposited by IBAD at room temperature has a good quality, in the sense that the interface thereof has no or few defects such as precursors. The latter could indeed be present if the layer was deposited by ALD, and therefore could alter the quality of the interface and therefore degrade the electron affinity and thus the responsivity β of the diode. In addition, it should be noted that this insulating layer 23 made of silicon oxide is not produced by thermal oxidation of an underlying silicon layer, insofar as the underlying layer is herein the insulating layer 22. Thermal oxidation would additionally require the stack to be brought to high temperature, which can be detrimental in terms of the thermal budget of the readout circuit.

Preferably, the stack of the MIIM diode has dimensions in the XY plane between 40 nm×40 nm and 100 nm×100 nm, for example equal to 50 nm×50 nm. The portions 11 and 12 of the antenna 10 may have a length, along the X axis, between 2 and 3 μm in the case of absorption in the LWIR band. This length can be defined, for each portion 11, 12, in the area that widens. It should be noted that FIG. 2B is very schematic: the antenna 10 may have a different bow-tie shape.

The rectenna 1 also includes a DC filter (not shown), electrically connected to the diode 20, so as to filter the rectified AC electrical signal so as to keep only the DC continuous component. Subsequently, the filter is electrically connected to a readout circuit of the electrical signal (optical detection application) or to an electrical load (energy conversion application).

An electric source may be present so as to electrically bias the diode 20 at a bias voltage V_{D}. By way of example, the metal layer M1 is grounded while the metal layer M2 is brought to the electrical potential U_{D}, which may be zero or not depending on the targeted application. Preferably, in the case of an optical detection application, the electrical potential U_{D} applied to the metal layer 24 is positive and higher than that applied to the metal layer 21. The electrical voltage V_{D} may be between about 0 and 0.3 V.

It should herein be reminded that the performances of the rectenna 1 depend in particular on the dynamic resistance R_{D} of the diode 20, the asymmetry As_{D} of the I(V) characteristic, and the responsivity β. The dynamic resistance R_{D} may be determined from the relationship R_{D}=1/I′, where I′ is the first derivative of the electric current I as a function of the electrical voltage V, at the bias voltage V_{D}. The asymmetry As_{D} may be determined from the relationship As_{D}=|If/Ir|, at the bias voltage V_{D}, where I_{f} is the value of the direct electric current and Iᵣ is that of the reverse electric current. Finally, the responsivity β has been defined before and may be determined by the relationship: β=I″/(2I′).

Thus, the rectenna 1 comprises a diode of the MIIM type where the insulating layer 23 is made of a silicon oxide with a thickness of 0.5 to 2 nm, while the insulating layer 22 has an electron affinity and a dielectric constant higher than those of the silicon oxide. Due to these features, the MIIM diode 20 has a better confinement of the electric field due to the insulating layer 23 made of low-thickness silicon oxide (low-k material), which contributes to increasing the responsivity and bandwidth of the diode 20. In addition, the electron affinity contrast helps to improve the asymmetry of the feature I(V) of the diode 20. Moreover, the insulating layer 22 is preferably made of a high-k material, which makes it possible to optimize the dynamic resistance. Finally, the fact that the low-thickness silicon oxide is formed by IBAD at room temperature enables obtaining a good quality oxide having the desired thickness, which makes it possible to preserve the good performance of the diode. The rectenna 1 then has improved performances compared to that of conventional MIIM diode rectennas.

By way of example, an infrared rectenna 1 adapted to absorb in the LWIR, and comprising an MIIM diode 20 is considered. The antenna 10 is of the bow-tie type and has a total length L in the range of λ_{c}/2 along the main X-axis, where λ_{c} is the central wavelength of the LWIR radiation to be detected. To detect a central wavelength λ_{c}=10.6 μm in the case of the presence of an underlying dielectric material of index nᵣ under the antenna, the wavelength for which the antenna is adapted is λ_{eff}=6.20 μm. In this case, the length L of the bow-tie antenna is herein between about 3 and 5 μm, and the length is preferably equal to 4 μm, and the angular opening of the triangular conductive portions 11, 12 of the antenna 10 is in the order of 60°. The antenna 10 is located above the metal reflector 35, and is spaced apart therefrom vertically by a thickness in the range of λ_{c}/4n, where n is the optical index of the medium 37 separating the antenna 10 from the reflector 35. Herein, this medium 37 is a silicon oxide with a thickness in the range of about 1 μm. Thus, a quarter-wave cavity is formed which improves the rate of absorption by the antenna 10.

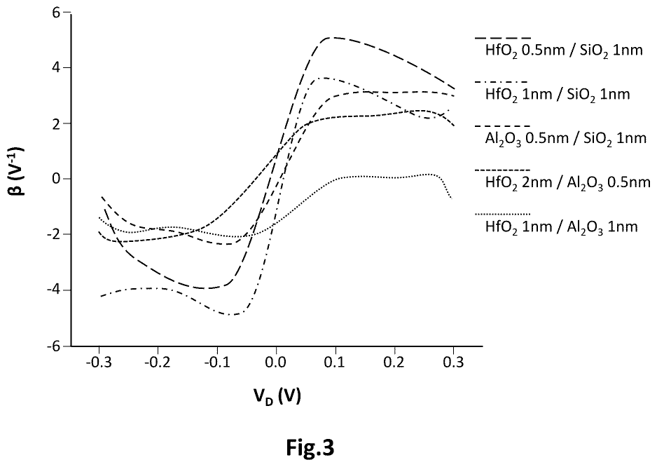

FIG. 3 illustrates an example of evolution of the responsivity β of the MIIM diode as a function of the bias voltage V_{D}.

A plurality of pairs of insulating materials I1, I2 are illustrated. In these various cases, the metal layer 21 is made of TiN (Ψ_{M1}=4.3 eV) and the metal layer 24 is made of Ni (Ψ_{M2}=5 eV). The diode has dimensions of 100 nm×100 nm in the XY plane.

First, the change in the responsivity β of a diode is measured, in the case where the insulator I2 of the diode is not made of a silicon oxide (i.e. conventional MIIM diode): a pair of insulators is thus considered where I1 is HfO with a thickness of 1 nm and I2 is Al₂O₃ with a thickness of 1 nm. It should be noted that the responsivity β has a very low value, close to 0 V⁻¹, for a voltage V_{D} of 0.1 V. However, in the case where the thicknesses change to 2 nm for HfO₂ and to 0.5 nm for Al₂O₃, the responsivity β increases to about 2 V⁻¹ for a voltage V_{D} of 0.1 V.

The evolution of the responsivity β of a diode 20 according to one embodiment of the invention is subsequently measured, in the case where the insulator I2 of the diode is made of a silicon oxide with a thickness between 0.5 and 2 nm. First, a pair of insulators is considered where I1 is HfO₂ with a thickness of 1 nm and I2 is SiO₂ with a thickness of 1 nm. It is noted that the responsivity β has a value that is close to 4 V⁻¹ for the voltage V_{D} of 0.1 V. If compared with the previous case where I2 is Al₂O₃ and where the thicknesses are identical, it is noted that the responsivity β has changed from an almost zero value to about 4 V⁻¹. The improvement is therefore very important.

This value can be improved by adjusting the thicknesses. Thus, for a pair of insulators where I1 is HfO₂ with a thickness of 0.5 nm and I2 is SiO₂ with a thickness of 1 nm, the responsivity β increases to more than 5 V⁻¹ for the same voltage value V_{D}. It should be noted that other materials also have a high responsivity, as for example with the pair of insulators where I1 is Al₂O₃ with a thickness of 0.5 nm and I2 is SiO₂ with a thickness of 1 nm, the responsivity β is equal to about 2.5 V⁻¹, therefore much higher than in the case of a conventional diode where the insulator I2 is not a silicon oxide. Moreover, it should be noted that the fact of producing an insulating layer 23 made of a silicon oxide with a thinner thickness, for example of 0.5 nm, will result in a decrease in the dynamic resistance and in an increase in the responsivity β of the diode.

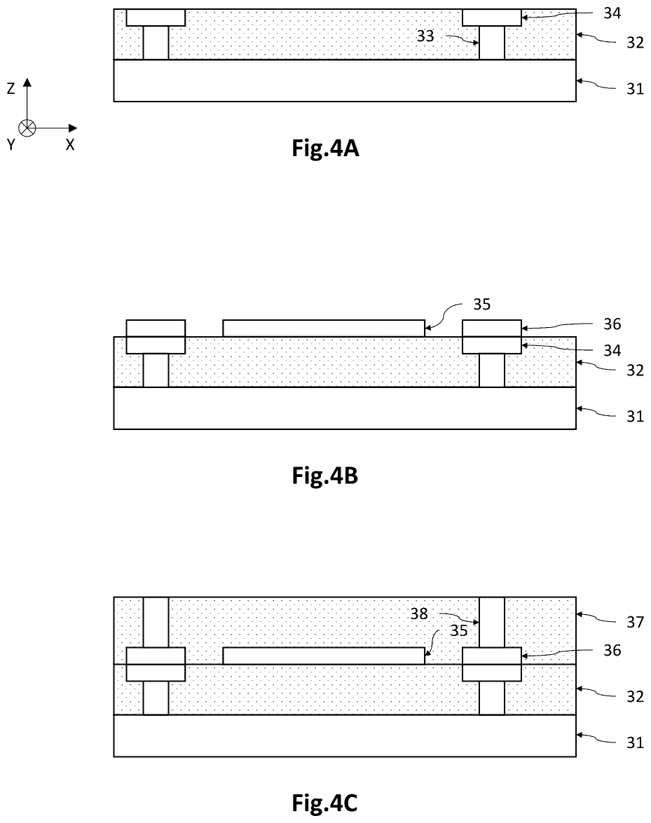

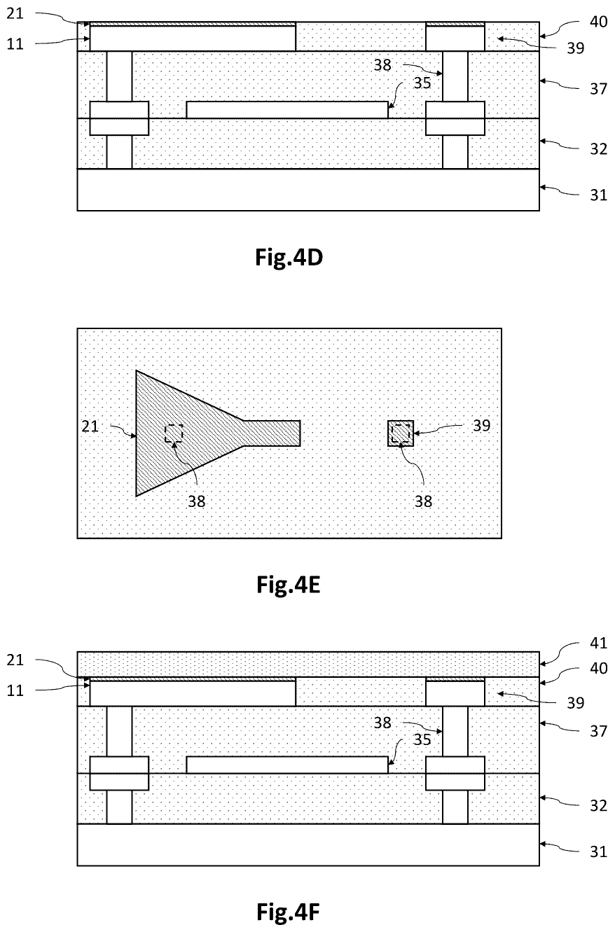

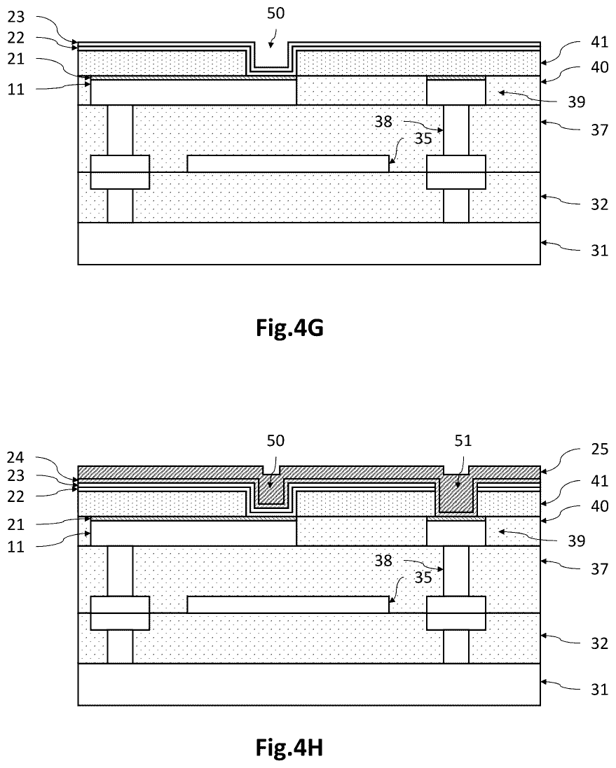

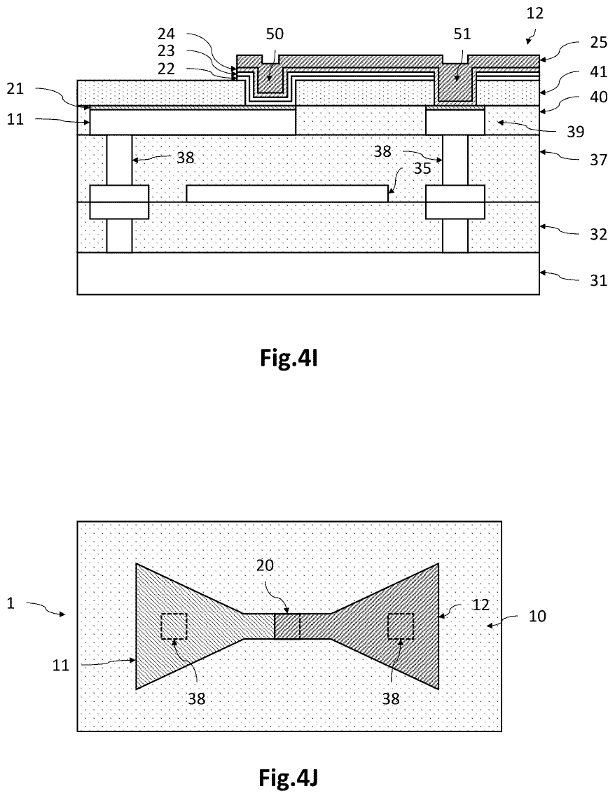

FIGS. 4A to 4J illustrate various steps of a method for manufacturing a rectenna 1 according to one embodiment. The rectenna 1 is herein adapted to absorb an electromagnetic radiation of interest in the LWIR. One single rectenna is shown herein but, preferably, the method covers the manufacture of an array of identical rectennas on the same readout substrate 31.

As indicated previously, the insulating layer 23 is made of a silicon oxide with a thickness of 0.5 to 2 nm by Ion Beam Assisted Deposition (IBAD) at room temperature and not by Atomic Layer Deposition (ALD), and even less by thermal oxidation.

With reference to FIG. 4A, a readout substrate 31 is provided, containing a readout and control circuit (ROIC), for example of the CMOS type, herein adapted to electrically bias the diode and to read the rectified electrical signal originating from the rectenna in response to the absorption of the LWIR radiation.

The readout substrate 31 is covered by a lower insulating layer 32, made of an insulating material such as a silicon oxide. Subsequently, first conductive vias 33, connected to connection pads of the readout substrate 31 (not shown), and then first electrical connection pads 34 in contact with the conductive vias 33, are made throughout the lower insulating layer 32.

With reference to FIG. 4B, the reflector 35 and intermediate connection pads 36 are subsequently produced. For this purpose, a layer made of at least one metal material is deposited, which is structured by lithography and localized etching to form the reflector 35 and connection pads 36. The metal layer may be a multilayer, for example of the Ti/TiN/AlCu or Ti/TiN/AlSi type. AlCu or AlSi may have a thickness of at least 80 nm, for example equal to 300 nm. The connection pads 36 are in electrical contact with the connection pads 34.

With reference to FIG. 4C, an intermediate insulating layer 37, made of an insulating material such as a silicon oxide, is deposited so as to subsequently define the quarter-wave cavity with the antenna. Thus, it is possible to deposit SiO₂ by plasma-enhanced chemical vapor deposition (PECVD), with a thickness for example between 0.3 and 2 μm, for example 1.2 μm, at a deposition temperature lower than or equal to 400° C. to comply with the thermal budget of the CMOS readout circuit. A chemical mechanical polishing step may subsequently be carried out to remove excess material and planarize the intermediate insulating layer 37 to a thickness of about 1 μm (the optical cavity has a thickness of λ/4n where n is the refractive index of the medium forming the optical cavity). Subsequently, second conductive vias 38 are produced throughout the intermediate insulating layer 37, in contact with the connection pads 36.

With reference to FIG. 4D and to FIG. 4E, the lower conductive portion 11 of the antenna as well as the lower metal layer 21 of the diode are subsequently produced. For this purpose, a layer made of at least one metal material, which is structured by lithography and etching, is deposited. Preferably, the layer is formed of a metal multilayer, for example made of Ti/TiN/AlCu. This multilayer forms both the lower conductive portion 11 of the antenna and the lower metal layer 21 made of TiN of the diode. The metal layer made of AlCu has a thickness preferably greater than 80 nm to ensure the quality and the continuity of the metal layer. From the multilayer, an upper connection pad 39, intended to bias the upper conductive portion of the antenna, is also formed. Subsequently, an upper insulating layer 40, for example made of a TEOS-type silicon oxide, is deposited which is planarized to clear the upper face of the metal layer 21 of the diode as well as that of the upper connection pad 39.

With reference to FIG. 4F, an insulating layer 41 is subsequently deposited covering the metal layer 21, the connection pad 39, and the upper insulating layer 40. This insulating layer 41 may be made of SiO₂ with a thickness between about 20 and 100 nm.

With reference to FIG. 4G, a localized opening 50 is made through the insulating layer 41, which opens at a border of the metal layer 21 where the diode will be located. This opening 50 may be produced by electron beam photolithography (e-beam), and may have a dimension in the XY plane in the order of 40 nm to 100 nm. The insulating layer 41 is etched with an etching stop on or in the metal layer 21.

The first insulating layer 22 is subsequently produced, herein by atomic layer deposition (ALD) at a temperature between about 200 and 400° C., for example 300° C. It has herein a thickness in the order of 1 to 3 nm. A high-k material having a high electron affinity, for example HfO₂ or ZnO, is preferably selected. This insulating layer 22 continuously covers the insulating layer 41 as well as the bottom and the side wall of the opening 50. It is therefore in contact and completely covers the metal layer 21.

The second insulating layer 23 is subsequently produced. It is formed from a silicon oxide, herein SiO₂ with a thickness between 0.5 and 2 nm. It is therefore a low-k material (εᵣ₂=about 2) having a low electron affinity (φ₂=0.9 eV). So as to obtain a good quality SiO₂ insulating layer at the interface, it is produced by IBAD at room temperature (around 25° C.). This insulating layer 23 continuously covers the insulating layer 22, both above the insulating layer 41 and in the opening 50. It is therefore in contact and completely covers the insulating layer 22.

The oxide deposition is constructed from a ceramic SiO₂ target. In the deposition support, oxygen can be introduced by two sources called Dep and Assist. When no voltage is applied to the Assist source, radical oxidation is obtained. In other words, the O⁻radicals are ejected into the chamber with very low kinetic energy. On the other hand, when the O⁻radicals are ejected using also the Assist source, ion oxidation is obtained, and this is then called ion beam assisted deposition (IBAD). Preferably, the insulating layer 23 is produced in SiO₂ by IBAD, insofar as SiO₂ is obtained, deposited on the underlying insulating layer 22, of very low thickness (in this case 0.5 nm) and of very good quality.

With reference to FIG. 4H, a second opening 51 is produced locally passing through the SiO₂ insulating layer 23, the insulating layer 22, the insulating layer 41, to open onto the connection pad 39 (herein on the metal layer 21).

The metal layer 24 of the diode 20 is subsequently produced. It is deposited so as to cover the SiO₂ insulating layer 23 in the opening 50. Herein, it also extends outside the opening 50, therefore above the insulating layer 41, but also in the second opening 51 This metal layer 24 may be, for example, a metal having a low output work, for example in the order of 4 eV, such as Ti, Cr, TiN, inter alia. It may be produced by evaporation or by CVDor ALD deposition.

An upper metal layer 25 intended to form the upper part 12 of the antenna 10 is subsequently deposited. This layer 25 covers and is in contact with the metal layer 24 at the diode 20, as at the connection pad 39. This layer may be made of Al, Au, Pt, Ni, Cr, inter alia.

With reference to FIG. 4I and FIG. 4J, the metal layer 25 is structured to form the upper part 12 of the antenna 10, by photolithography and localized etching. Here, the metal layer 24, the insulating layer 23 made of SiO₂ and the insulating layer 22 are also etched, with an etching stop on the insulating layer 41 made of TEOS. The diode 20 is therefore biased by the two lower 11 and upper 12 portions of the antenna 10 and by the conductive vias 38.

Thus, a rectenna 1 formed by an antenna 10, herein of the bow-tie type, and a MIGIM diode 20 located between the two apexes of the triangular conductive portions of the antenna 10, is obtained. The diode 20 is biased by means of conductive vias 38 which extend between the conductive portions 11, 12 of the antenna 10 and the readout circuit. In addition, the antenna 10 is vertically spaced apart from a reflector 35, thus forming a quarter-wave cavity optimizing the absorption of the LWIR radiation. Insofar as the MIIM diode 20 contains the insulating layer 23 made of silicon oxide, herein SiO₂, with a thickness of 0.5 to 2 nm of good quality as deposited by IBAD, the diode 20 has improved performances, in particular in terms of responsivity.

Particular embodiments have just been described. Various alternative embodiments and modifications will become apparent to the person skilled in the art.

1. A rectifying antenna for detecting electromagnetic radiation, comprising:
an antenna, configured to absorb the electromagnetic radiation;
a diode of the Metal-Insulator-Insulator-Metal type, electrically coupled to the antenna, successively comprising: a first metal layer, a first insulating layer
made of a first electrical insulator of electron affinity φ₁, a second insulating layer made of a second electrical insulator of electron affinity φ₂ lower than φ₁, and a second metal layer;
wherein the second electrical insulator has a dielectric constant εr₂ lower than the dielectric constant εr₁ of the first electrical insulator, and is a silicon oxide with a thickness between 0.5 and 2 nm.

2. The rectifying antenna according to claim 1, wherein the first electrical insulator is selected from Al₂O₃, ZrO₂, HfO₂, ZnO and HfAlO.

3. The rectifying antenna according to claim 1, wherein the first electrical insulator is made of HfO₂ or ZnO.

4. The rectifying antenna according to claim 1, wherein the first insulating layer has a thickness between 0.5 and 4 nm.

5. The rectifying antenna according to claim 1, wherein the first metal layer, the first insulating layer, the second insulating layer, and the second metal layer form a stack having dimensions between 40×40 nm and 100×100 nm.

6. The rectifying antenna according to claim 1, wherein, in the diode, each of the metal and insulating layers is in continuous contact with the adjacent layer over its entire surface.

7. The rectifying antenna according to claim 1, comprising an electric source configured to apply a non-zero bias electrical voltage V_{D} to the diode.

8. The rectifying antenna according to claim 7, wherein the electric source is configured to apply an electrical potential to the first and to second metal layers, wherein the electrical potential applied to the second metal layer is higher than that applied to the first metal layer.

9. The rectifying antenna according to claim 1, wherein the first metal layer has an electrical potential equal to that of the second metal layer.

10. The rectifying antenna according to claim 1, comprising a support substrate and a reflector for the electromagnetic radiation of interest, disposed between the support substrate and the antenna, and spaced apart from the antenna so as to form a quarter-wave cavity.

11. The rectifying antenna according to claim 1, wherein the antenna is configured to absorb an infrared or terahertz electromagnetic radiation.

12. An optoelectronic device, comprising an array of rectifying antennas according to claim 1, identical to one another.

13. A method for manufacturing at least one rectifying antenna according to claim 1, comprising the following steps:
forming a first conductive portion of the antenna;
forming the first metal layer of the diode, extending over and in contact with the first conductive portion of the antenna;
forming a first continuous insulating layer, covering the first metal layer and the first conductive portion of the antenna;
forming a first opening, disposed at a proximal end of the first conductive
portion of the antenna, opening onto the first metal layer;
forming the first insulating layer extending into the first opening and coming into contact with the first metal layer;
forming the second insulating layer by ion beam assisted deposition, wherein the second insulating layer is made of a silicon oxide with a thickness of between 0.5 and 2 nm, and extend into the first opening and into contact with the first insulating layer;
forming the second metal layer, extending into the first opening and coming into contact with the second insulating layer;
forming a second conductive portion of the antenna extending over and in contact with the second metal layer.
